(19) United States
(12) Patent Application Publication
(10) Pub. No.: US 2008/0003404 A1
(43) Pub. Date: Jan. 3, 2008

(54) FLEXIBLE CIRCUIT

(75) Inventors: Rui Yang, Austin, TX (US); Nathan P. Kreutter, Austin, TX (US); Mark M. Lettang, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/768,074

(22) Filed: Jun. 25, 2007

Related U.S. Application Data
(60) Provisional application No. 60/806,398, filed on Jun. 30, 2006.

(51) Int. Cl. B32B 3/10; D01D 5/24

(52) U.S. Cl. 428/131; 264/209.8; 428/141

(57) ABSTRACT

Provided is an article comprising a first polymeric substrate having in its surface at least one open channel comprising walls and a bottom surface and at least one conductive feature on the polymeric substrate surface wherein at least a portion of at least one conductive feature is located in at least one open channel. Also provided is an article comprising a polymeric substrate having on its surface at least one sloped conductive feature.

### CROSS-REFERENCE TO RELATED APPLICATIONS

The present application claims priority to U.S. Provisional Patent Application 60/806,398, filed Jun. 30, 2006.

### TECHNICAL FIELD

This invention relates to a flexible circuit having a sloped conductive feature.

### BACKGROUND

An etched copper circuit pattern over a polymer film base may be referred to as a flexible circuit. Originally designed to replace bulky wiring harnesses, flexible circuitry is often the only solution for the miniaturization and movement needed for current, cutting-edge electronic assemblies. Thin, lightweight and ideal for complicated devices, flexible circuit design solutions range from single-sided conductive paths to complex, multilayer packages. The use of flexible circuits is known, for example, in electronic devices including ink jet print heads, mobile hand held devices, and hard disk drive suspension assemblies.

### SUMMARY

One aspect of the present invention features an article comprising a first polymeric substrate having in its surface at least one open channel comprising walls and a bottom surface and at least one conductive feature on the polymeric substrate surface wherein at least a portion of at least one conductive feature is located in at least one open channel.

Another aspect of the present invention features a method comprising forming at least one channel in the surface of a first polymeric substrate and forming at least one conductive feature on the polymeric substrate surface such that at least a portion of at least one conductive feature is located in at least one channel.

Another aspect of the present invention features an article comprising a polymeric substrate having on its surface at least one sloped conductive feature.

As used in this invention:

“sloped conductive feature” means a portion of conductive feature, such as a trace, that follows the contours of the underlying polymeric substrate and is non-parallel to an x-y plane of a major polymeric substrate surface and non-parallel to a vertical z direction;

“open channel” means substantially open to the atmosphere;

“closed channel” means substantially closed to the atmosphere;

“bi-planar” or “multi-planar” means having different portions of a single surface in two or more substantially parallel planes; and

“aspect ratio” means width to depth.

An advantage of at least one embodiment of the present invention is that a microfluidic device with a polymer substrate allows high volume low cost manufacturing.

An advantage of at least one embodiment of the present invention is that it allows the creation of microfluidic channels of controlled geometry in polymeric of substrates.

An advantage of at least one embodiment of the present invention is that it allows a feasible and cost-effective method of electrode formation, configuration and integration in a microfluidic device.

An advantage of at least one embodiment of the present invention is that it may be used as a building block to construct multiple layer circuits with a simplified design and more reliable performance.

Other features and advantages of the invention will be apparent from the following drawings, detailed description, and claims.

### BRIEF DESCRIPTION OF DRAWINGS

FIG. 1 is a digital image of an SEM of an article of the present invention showing a cross-section of an etched channel in a polymeric substrate.

FIG. 2 is a digital image of an SEM of an article of the present invention showing a perspective view of an etched channel in communication with a through-hole in a polymeric substrate.

FIG. 3 is a digital image of an SEM of the article shown in FIG. 2 shown from the opposite side of the polymeric substrate.

FIG. 4 is a digital image of an SEM of an article of the present invention showing a perspective view of a developed dry film photoresist spanning an etched channel in a polymeric substrate.

FIG. 5 is a digital image of an SEM of an article of the present invention showing a perspective view of a developed liquid photoresist in an etched channel in a polymeric substrate.

FIG. 6 is a digital image of an SEM of an article of the present invention showing a perspective view of an etched channel in a polymeric substrate traversed by metal traces.

FIG. 7 illustrates an article of the present invention showing a cross-section of an article having a uni-lateral sloped conductive feature.

FIG. 8 is a digital image of an SEM of an article of the present invention showing a cross-section of etched channels in a polymeric substrate with a polymeric film cover.

FIG. 9 is a digital image of an SEM of an article of the present invention showing a cross-section two polymeric substrates each having an etched channel adhered together such that the channels align.

### DETAILED DESCRIPTION

An aspect of the present invention is a three dimensional (3D) flexible circuit. Current single metal flex circuit has metal traces only on a surface in an x-y direction. A 3D flexible circuit of the present invention provides a sloped metal trace. It allows metal traces to be located at different plane levels within a single circuit.

This 3D circuit may be used as a building block to construct multiple layer circuits with a simplified design and more reliable performance. New functional features such as channels with integrated electrodes and/or electrical circuits, connections between differing levels of circuits, and connector arrays on a thinned portion of a circuit are provided through the sloped metal traces and multi-level single metal traces within a single metal layer design, which allows for the use of more complicated flex circuit designs in new application.

An example of an application that would benefit from the 3D flex circuit capability would be a dielectrophoretic cell/particle focusing circuit which could be used in place of the complicated hydrodynamic focusing systems traditionally used to focus cells into the center of the flow channel in flow cytometry. The paper Dielectrophoresis Based Micro Flow Cytometry by Vykoukal et al. (7th International Conference on Miniaturized Chemical and Biochemical Analysis Systems, Oct. 5-9, 2003, Squaw Valley, Calif.) describes a glass/Si implementation of this application. A polymeric film implementation of this application, enabled by at least one embodiment of the present invention, has numerous benefits over glass/Si including more channel formation options, substrate flexibility, and reduced cost.

An application for the articles of the present invention is microfluidics. Articles having channels and electric circuits provide a way to introduce microfluidic elements into electronic packages. It is conceivable to use micro-electromechanical systems (MEMS) devices, connected through the electric circuits, to analyze chemical fluids and analytes flowing through the channels formed in the circuit substrate.

Typical microfluidic devices have channels with widths between about 10 and about 200 μm, more typically between about 15 and about 100 μm, and depths between about 10 and about 70 μm. A suitable package may be rigid or flexible. A rigid package may include a flexible circuit with one or more rigidizing layers.

A particular application for a flexible circuit of the present invention is in a dielectrophoretic cell/particle focusing circuit may be formed by adhering a 3D flex circuit to either a second 3D flex circuit, or to a traditional 2D flex circuit to form a closed channel that has electrodes across its walls. In this cell/particle focusing application, the 3D flex circuit may have electrodes patterned on the walls of the formed channel, in an orientation perpendicular to the length of the channel. A non-conductive adhesive may be used to insure the electrodes from the opposing circuits are not electrically shorted together when the opposing circuits are adhered together to form a closed channel.

Polymeric films of the present invention may be, but are not limited to, polycarbonates, liquid crystal polymers, and polyimides, including polyimide polymers having carboxylic ester units in the polymeric backbone. Examples of other suitable polymeric substrate materials include, but are not limited to polyethylene terephthalate (PET), polyethylene naphthalene (PEN), substituted and unsubstituted PET and PEN, PET and PEN blends, and PET and PEN copolymers.

The polymeric films may be made of a single material or may be made of layers of two or more different materials. The layers may be adhesively or non-adhesively joined together.

Polyimide film is a commonly used substrate for flexible circuits that fulfill the requirements of complex, cutting-edge electronic assemblies. The film has excellent properties such as thermal stability and low dielectric constant.

Examples of suitable polyimide materials are those that comprise monomers of pyromellitic dianhydride (PMDA), or oxydianiline (ODA), or biphenyl dianhydride (BPDA), or phenylene diamine (PPD). Polyimide polymers including one or more of these monomers may be used to produce film products such as those designated under the trade names KAPTON H, K, E films (available from E. I. du Pont de Nemours and Company, Circleville, Ohio) and APICAL AV and NP films (available from Kaneka Corporation, Otsu, Japan). However, as is explained in more detail below, these types of films swell in the presence of typical chemical etchant. Accordingly, if a chemical etching method is used to form channels or features in the film, a polyimide film having carboxylic ester structural units in the polymeric backbone such as APICAL HPNF films (available from Kaneka Corporation, Otsu, Japan) is preferred. APICAL HPNF polyimide film is believed to be a copolymer that derives its ester unit containing structure from polymerizing of monomers including p-phenylene bis(trimellitic acid monoester anhydride). Other ester unit containing polyimide polymers are not known commercially. However, to one of ordinary skill in the art, it would be reasonable to synthesize other ester unit containing polyimide polymers depending upon selection of monomers similar to those used for APICAL HPNF. Such syntheses could expand the range of polyimide polymers for films, which, like APICAL HPNF, may be controllably etched. Materials that may be selected to increase the number of ester containing polyimide polymers include 1,3-diphenol bis(anhydro-trimellitate), 1,4-diphenol bis(anhydro-trimellitate), ethylene glycol bis(anhydro-trimellitate), biphenol bis(anhydro-trimellitate), oxy-diphenol bis(anhydro-trimellitate), bis(4-hydroxyphenyl sulfide) bis(anhydro-trimellitate), bis(4-hydroxybenzophenone) bis(anhydro-trimellitate), bis(4-hydroxyphenyl sulfone) bis(anhydro-trimellitate), bis(hydroxyphenoxybenzene), bis(anhydro-trimellitate), 1,3-diphenol bis(aminobenzoate), 1,4-diphenol bis(aminobenzoate), ethylene glycol bis(aminobenzoate), biphenol bis(aminobenzoate), oxy-diphenol bis(aminobenzoate), bis(4aminobenzoate) bis(aminobenzoate), and the like.

LCP films represent suitable materials as substrates for flexible circuits having improved high frequency performance, lower dielectric loss, and less moisture absorption than polyimide films. Characteristics of LCP films include electrical insulation, moisture absorption less than 0.5% at saturation, a coefficient of thermal expansion approaching that of the copper used for plated through holes, and a dielectric constant not to exceed 3.5 over the functional frequency range of 1 kHz to 45 GHz.

Some embodiments of the present invention may use a laminated composite in which the polymeric layer is extruded and tentered (biaxially stretched) liquid crystal polymer films. A process development, described in U.S. Pat. No. 4,975,312, provided multiaxially (e.g., biaxially) oriented thermotropic polymer films of commercially available liquid crystal polymers (LCP) identified by the trade names VECTRA (naphthalene based, available from Hoechst Celanese Corp.) and XYDAR (biphenol based, available from Amoco Performance Products). Multiaxially oriented LCP films of this type represent suitable substrates for flexible printed circuits and circuit interconnects suitable for production of device assemblies such as microfluidic devices.

Characteristics of polycarbonate films include electrical insulation, moisture absorption less than 0.5% at saturation, a dielectric constant not to exceed 3.5 over the functional frequency range of 1 kHz to 45 GHz, better chemical resistance when compared to polyimide, lower modulus, and an optical clarity that will allow the formation of microfluidic devices to be used in conjunction with a variety of spectrographic techniques in the ultraviolet and visible light domains. Polycarbonates also have lower water absorption than polyimide and lower dielectric dissipation.

Examples of suitable polycarbonate materials include substituted and unsubstituted polycarbonates; polycarbonate blends such as polycarbonate/aliphatic polyester blends, including the blends available under the trade name XYLEX from GE Plastics, Pittsfield, Mass., polycarbonate/polyethyleneterephthalate (PC/PET) blends, polycarbonate/polybutyleneterephthalate (PC/PBT) blends, and polycarbonate/poly(ethylene 2,6-naphthalate) ((PPC/PBT, PC/PEN) blends, and any other blend of polycarbonate with a thermoplastic resin; and polycarbonate copolymers such as polycarbonate/polyethyleneterephthalate (PC/PET) and polycarbonate/polyetherimide (PC/PEI). Another type of material suitable for use in the present invention is a polycarbonate laminate. Such a laminate may have at least two different polycarbonate layers adjacent to each other or may have at least one polycarbonate layer adjacent to a thermoplastic material layer (e.g., LEXAN GS125DL which is a polycarbonate/polyvinyl fluoride laminate from GE Plastics). Polycarbonate materials may also be filled with carbon black, silica, alumina and the like or they may contain additives such as flame retardants, UV stabilizers, pigment and the like.

The features in the polymeric substrates of the articles of the present invention may be made by any suitable method such as plasma etching, chemical etching, laser etching, mechanical punching, and embossing. Features may include, for example, channels, through holes, reservoirs, bi-plane surfaces, and multi-plane surfaces.

If the polymeric substrate is made of two or more layers of different materials, for example a surface layer and a base layer beneath the surface layer, the interface of two layers may be used as an etch stop if the base layer is not etchable, or is etchable at a slower rate, by the same etching method used to etch the surface layer. A two-layer substrate may be useful in making an embodiment of the present invention in which the walls of a feature, such as a channel, are made of a different polymeric material than the bottom surface of the channel.

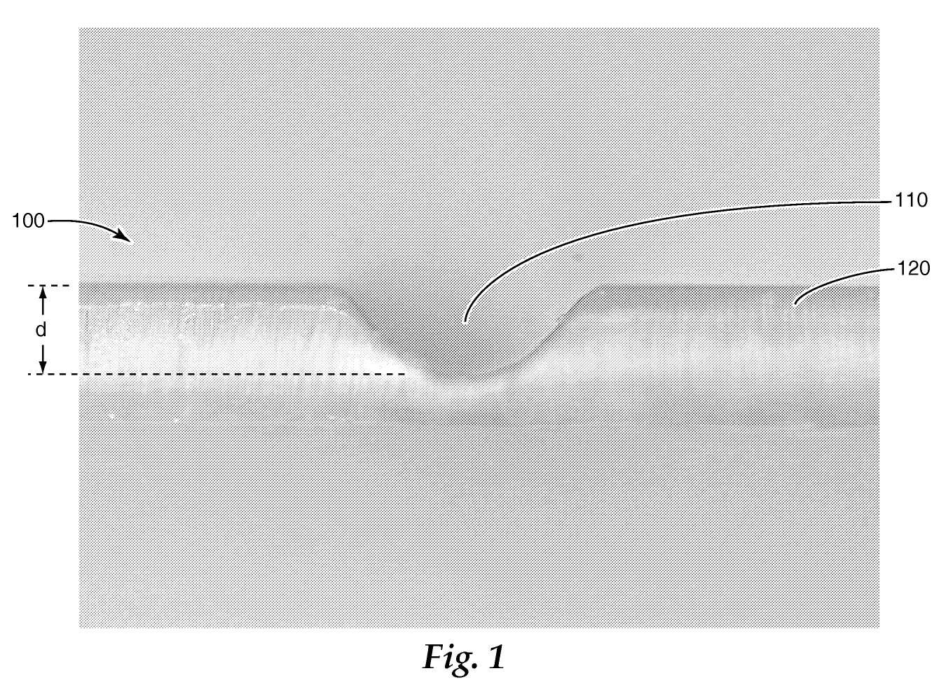

FIG. 1 illustrates an embodiment of the present invention comprising article 100 having a channel 110 formed in a polymeric film 120, the channel having a depth, d. A channel typically may be up to about 75% of the thickness of the polymeric material in which it is formed. Greater depths can lead to stability problems. Typical channel dimensions of interest for microfluidic devices are a channel width of about 10 μm to about 300 μm and a depth of about 10 μm to about 125 μm. The walls of the channels may be relatively straight, such that the channel walls and bottom surface form a rectilinear cross-section, or may be rounded, such that the channel walls and bottom surface form a curvilinear cross-section. The walls of the channels may have a sidewall angle in the range of 0° to about 90° relative to the surface of the polymeric film. In some embodiments, the sidewall angle will be in the range of about 45° to about 80°, and in other embodiments, the sidewall angle will be in the range of about 25° to about 45°. The aspect ratios of the channels will vary based on a number of factors. The greater the aspect ratio, the easier it is to deposit conductive material in the channel.

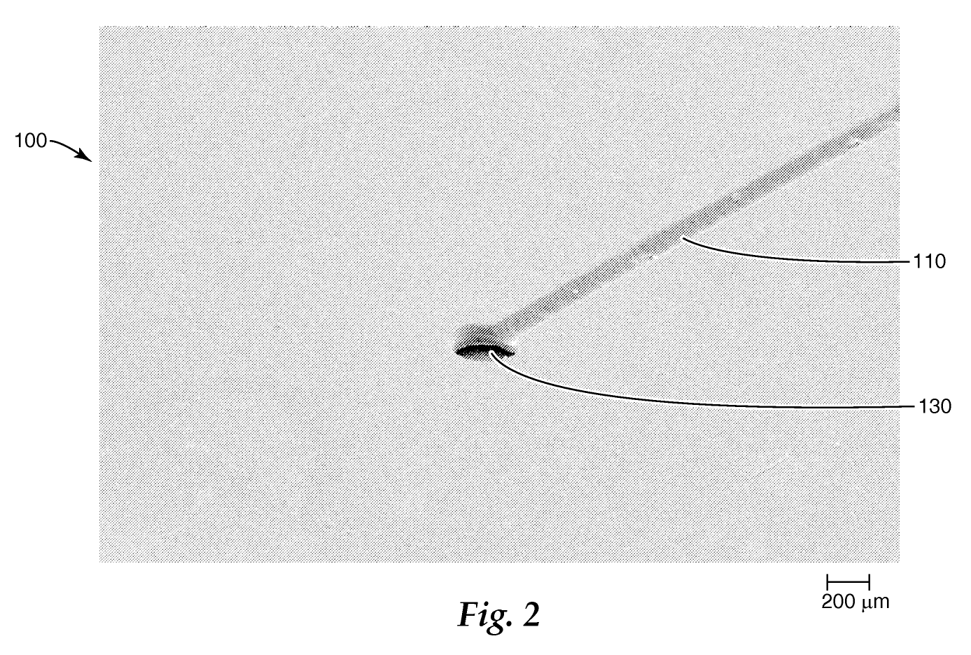

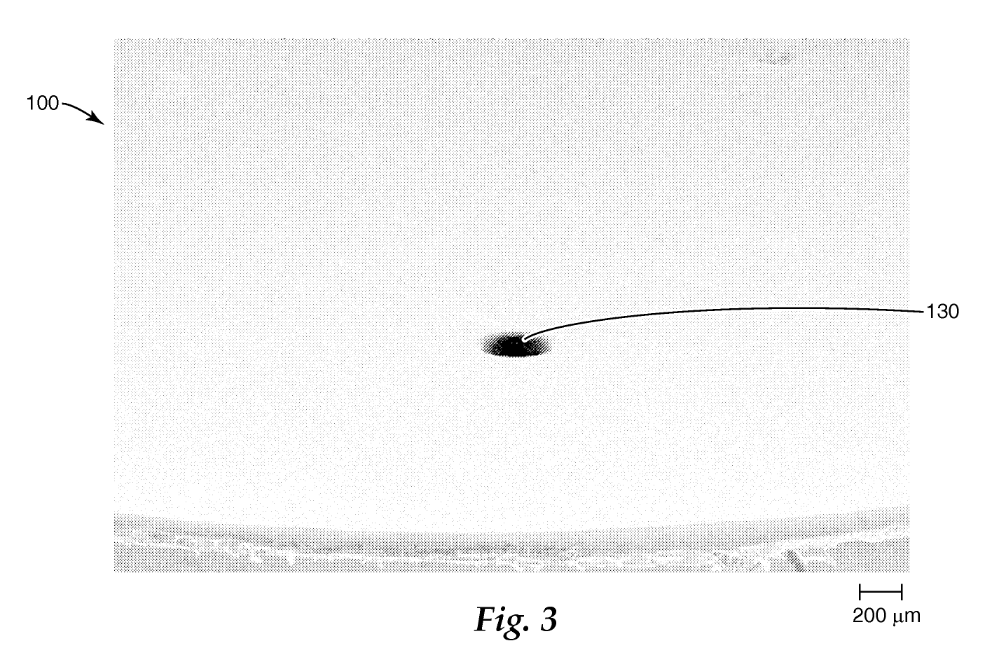

FIGS. 2 and 3 illustrate an embodiment of the present invention comprising article 100 having a through hole 130 in communication with channel 110. The through hole may be used, for example, as an input or output port for fluids in channel 110.

Chemical etching of a polymeric substrate may be carried out with a highly alkaline developing solution, referred to herein as an etchant. A suitable etchant may comprise an alkali metal salt and optionally a solubilizer. A solution of an alkali metal salt alone may be used as an etchant for polyimide but has a low etching rate when etching LCP and polycarbonate. However, when a solubilizer is combined with the alkali metal salt etchant, it can be used to effectively etch polyimide polymers having carboxylic ester units in the polymeric backbone, LCPs, and polycarbonates. For polycarbonates, adding ethylene glycol in a range of 3-10 weight % to the alkaline solution will increase the etch rate.

The formation of features such as channels, through holes, reservoirs, and bi- or multi-planar substrates, typically requires protection of portions of the polymeric film using a mask of a photo-crosslinked negative acting, aqueous processable photoresist, or a metal mask. For example, dry film aqueous processable photoresists may be laminated, or liquid aqueous processable photoresists may be coated, over both sides of the substrate, using standard laminating techniques. The thickness of the photoresist is typically from about 10 μm to about 50 μm. The photoresist on one or both sides is exposed to ultraviolet light or the like, through an imaging mask, causing the exposed portions of the photoresist become insoluble by crosslinking. The resist is then developed, by removal of unexposed polymer with a dilute aqueous solution, e.g., a 0.5-1.5% sodium carbonate solution, until the desired pattern is obtained. The photoresist pattern will include channels or other feature to be formed in the polymeric substrate. If a channel is to be formed on a top surface of a polymeric substrate, the entire bottom surface and the top surface other than the location of the channel will be covered with the photoresist. If a through hole is to be formed, the top and bottom surface at the location of the through hole may be exposed to the etchant by the photoresist pattern so that etching will occur from both sides. The exposed polymeric material is then exposed to a suitable etchant to form the desired features. The photoresist is then stripped from both sides of the laminate in a 2-5% solution of an alkali metal hydroxide at from about 25° C. to about 80° C., preferably from about 25° C. to about 60° C.

Negative photoresists suitable for use with polymeric films include negative acting, aqueous developable, photopolymer compositions such as those disclosed in U.S. Pat. Nos. 3,469,982; 3,448,098; 3,867,153; and 3,526,504. Such photoresists include at least a polymer matrix including crosslinkable monomers and a photoinitiator. Polymers typically used in photoresists include copolymers of methyl methacrylate, ethyl acrylate and acrylic acid, copolymers of styrene and maleic anhydride isobutyl ester and the like. Crosslinkable monomers may be multiacrylates such as trimethylol propane triacrylate.

Commercially available aqueous base, e.g., sodium carbonate developable, negative acting photoresists include polymethylmethacrylates photoresist materials such as those available under the trade name RISTON from E.I. duPont de Nemours and Co., e.g., RISTON 4720. Other useful examples include AP850 available from LeaRonal, Inc., Freeport, N.Y., and PHOTEC HU350 available from Hitachi Chemical Co. Ltd. Dry film photoresist compositions under the trade name AQUA MER are available from MacDermid, Waterbury, Conn. There are several series of AQUA MER photoresists including the “SF” and “CF” series with SF120, SF125, and CF2.0 being representative of these materials. Dry film photoresists such as those available under the trade designation Accuimage from Kolon Industries (Korea) may also be used.

If chemical etching is used to form channels in the polymeric substrate, it is preferable to use films that do not swell in the presence of standard chemical etchants. Suitable non-swelling polyimide films are those which contain carboxylic ester structural units in the polymeric backbone such as those available under the trade name APICAL HPNF from Kaneka Corporation, Otsu, Japan.

Liquid crystal polymers also contain carboxylic ester units in its polymer structure. Non-swelling liquid crystal polymer films may comprise aromatic polyesters including copolymers containing p-phenyleneterephthalamide such as BIAC film (Japan Gore-Tex Inc., Okayama-Ken, Japan) and copolymers containing p-hydroxybenzoic acid such as LCP CT film (Kuraray Co., Ltd., Okayama, Japan).

Polycarbonate films may be etched using solutions of potassium hydroxide and sodium hydroxide alone; however, the etch rate is slow. Polycarbonates can be readily etched when a solubilizer is combined with highly alkaline aqueous etchant solutions that comprise, for example, water soluble salts of alkali metals and ammonia.

Films made of polymers such as PET and PEN may also be chemically etched, but the etch rate is very slow.

Water soluble salts suitable for use in a chemical etching formulation include, for example, potassium hydroxide (KOH), sodium hydroxide (NaOH), substituted ammonium hydroxides, such as tetramethylammonium hydroxide and ammonium hydroxide or mixtures thereof. Useful alkaline etchants include aqueous solutions of alkali metal salts including alkali metal hydroxides, particularly potassium hydroxide, and their mixtures with amines, as described in U.S. Pat. Nos. 6,611,046 B1 and 6,403,211 B1. Useful concentrations of the etchant solutions vary depending upon the thickness of the polymeric film to be etched, as well as the type and thickness of the photoresist chosen. Typical useful concentrations of a suitable salt range in one embodiment from about 30 wt. % to 55 wt. % and in another embodiment from about 40 wt. % to about 50 wt. %.

Typically the solubilizer in the etchant solution is an amine compound, preferably an alkanolamine. Solubilizers for etchant solutions according to the present invention may be selected from the group consisting of amines, including ethylene diamine, propylene diamine, ethylamine, methylethylamine, and alkanolamines such as ethanolamine, diethanolamine, propanolamine, ethylene glycol, and the like. Typical useful concentrations of a suitable solubilizer range in one embodiment from about 10 wt. % to about 35 wt. % and in another embodiment from about 15 wt. % to about 30 wt. %. The use of KOH with a solubilizer is preferred for producing a highly alkaline solution because KOH-containing etchants provide optimally etched features in the shortest amount of time. The etching solution is generally at a temperature of from about 50° C. (122° F.) to about 120° C. (248° F.) preferably from about 70° C. (160° F.) to about 95° C. (200° F.) during etching.

The polymeric film can also be etched by a “dry” plasma process. In such a method, a plasma is formed in a controlled environment at a pressure from about 1 to 500 m Torr and a frequency from 100 khz to 2.45 Ghz. Typical process conditions include using a specific gas such as oxygen or a mixture of gases such as halocarbons. With these conditions, the highly reactive ions in the plasma easily react chemically to remove atoms of polymeric material from the film. The polymeric material can be removed selectively by using a metal mask or photoresist polymer mask. The molecular structures of different polymeric materials have different etch rates. A plasma etching method is anisotropic compared to wet chemistry process.

The polymeric film can also be etched by a laser process. A laser (having a highly concentrated beam of light) such as a Carbon Dioxide laser, operating at wavelengths of 2.6 to 8.3 μm; an excimer laser operating at wavelengths of 93 nm, 248 nm, 308 nm or 353 nm; or a YAG laser (yttrium-Aluminum-Garnet) laser, operating at wavelengths of 650 nm to 1.064 μm, can ablate or vaporize polymeric material. Lasers can be tuned to selectively remove a first layer of a material without etching an adjacent second layer by changing the wavelength, type of laser, and/or types of gasses used. Lasers typically leave a charred residue that then needs to be removed with subsequent processing.

Features such as channels and reservoirs may be formed in the polymeric substrate using micro-molding processes such as injection molding, embossing, hot embossing, or thermoforming. The paper Review on micro molding of thermoplastic polymers by M. Heckele and W. K. Schomburg, JOURNAL OF MICROMECHANICS AND MICROENGINEERING, vol. 14, pages R1-R14 (2004 Institute of Physics Publishing) describes how these processes may be used to form polymeric features in thermoplastic film with precision tooling.

An example of a micro-molding process is embossing. Embossing may include providing a die made of metal or another suitable material having a pattern of 3-D features in its surface. The die is pressed against the polymeric surface to be embossed, thereby forming a 3-D pattern on the polymeric surface having the mirror image of the die pattern.

A powered mechanical press can be used with various tools (e.g., dies, drills, cutting blades, etc.) to impart features in a surface of the polymeric material by removing a portion of the polymeric material.

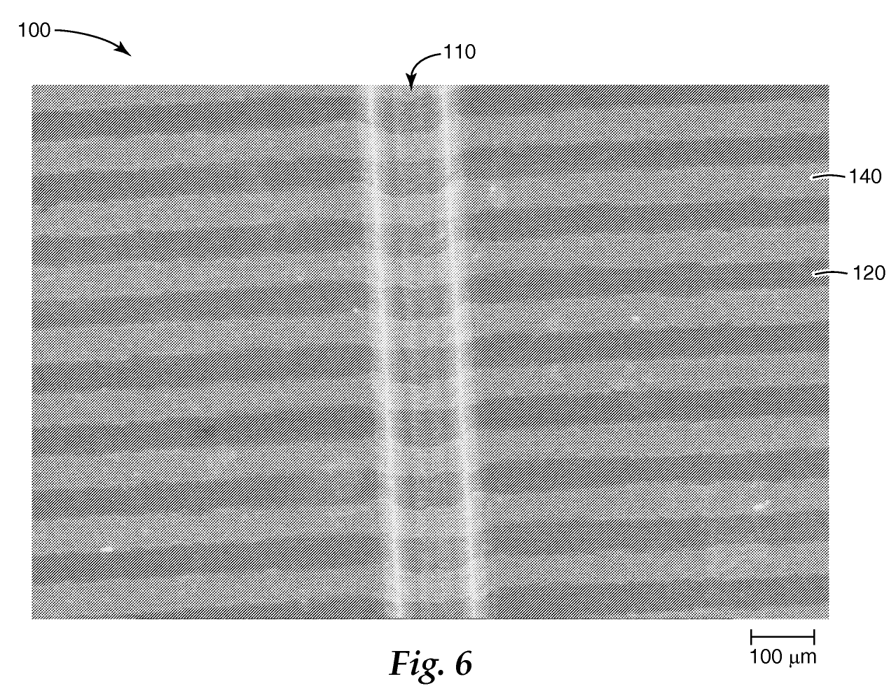

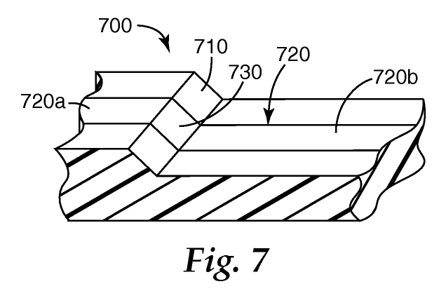

After the polymeric feature is formed, the conductive feature may be formed. The conductive feature may be formed by a number of methods such as those described herein. Conductive features such as circuits, traces, electrodes, leads, connector arrays, pads, power or ground planes, and electrical shielding could be configured in several ways depending on the application and function of the device. Conductive features could be positioned in or across any portion of the polymeric feature such that they have a sloped conductive feature. The sloped conductive feature may be uni-lateral or bi-lateral. For example, an electrical trace may traverse two or more planes of a bi-planar substrate and include a sloped trace portion at the transition between two planes. This would be a unilateral sloped conductive feature. An example of such a feature is illustrated by sloped conductive feature 730 in FIG. 7. An electrical trace may also traverse a substrate surface including following the contours of an open channel in the substrate. This would be a bi-lateral sloped conductive feature. An example of such a feature is illustrated by electrode 140 in FIG. 6.

Suitable conductive materials include copper, noble metals such as gold and silver, carbon, conductive metal oxide and alloys of any of the foregoing. Some embodiments may include tie layers such as nickel or chromium. Conductive materials may also be deposited in layers.

Examples of suitable methods for depositing conductive materials include subtractive and additive processes or a combination of the two. Descriptions of a subtractive-additive method and a semi-additive method are described in U.S. Published Patent application 2006/0131616, which descriptions are incorporated herein by reference. These processes may be used to form circuits containing copper, gold, and other metals and noble metals.

A typical subtractive process, employing a chemical etching process, to form, as an example, copper traces, may be described as follows:

A polymeric substrate having a feature on its surface is coated with a copper layer. The thickness of the copper layer is the approximate desired final thickness of the copper features. The copper layer is typically deposited by sputtering or vapor deposition. Optionally, a tie layer, containing, for example, chrome, nickel, nickel/chrome alloy, or chrome oxide may be deposited before the copper layer. Dry film aqueous processable photoresists are laminated, or liquid aqueous processable photoresists are coated, onto both sides of the copper-coated substrate, using standard laminating techniques. The thickness of the photoresist is from about 10 μm to about 50 μm. If the polymeric substrate feature has an aspect ratio of 3:1 or greater, a dry film resist may be used. If the polymeric substrate has an aspect ratio of less than about 3:1, a liquid resist may be required. The substrate typically consists of a polymeric film layer about 25 μm to about 125 μm thick with the copper layer being from about 5 μm to about 40 μm thick, and the optional tie layer being about 5 nm to about 30 nm thick. The photoresist on the copper-coated side of the substrate is exposed to ultraviolet light or the like, through an imaging mask, causing the exposed portions of the photoresist become insoluble by crosslinking. The image is then developed with a dilute aqueous solution until desired patterns are obtained on the laminate. The exposed copper is then etched to obtain the desired copper features, and portions of the polymeric layer thus become exposed. The photoresist is then stripped from both sides with a dilute basic solution in a 2-5% solution of an alkali metal hydroxide at from about 25° C. to about 80° C., preferably from about 25° C. to about 60° C. The etchant may be sprayed on the substrate or the substrate may be submerged in the etchant.

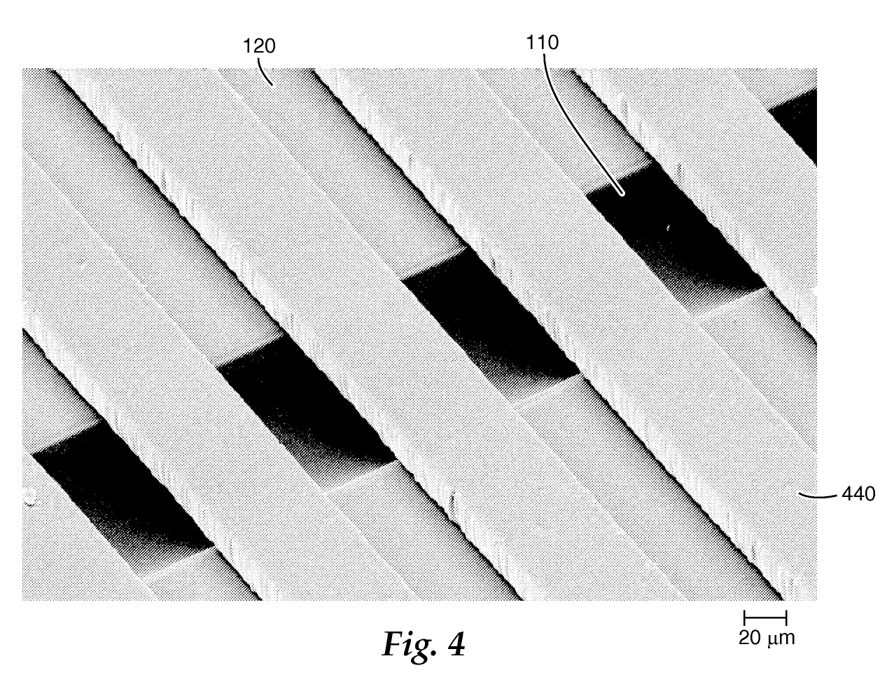

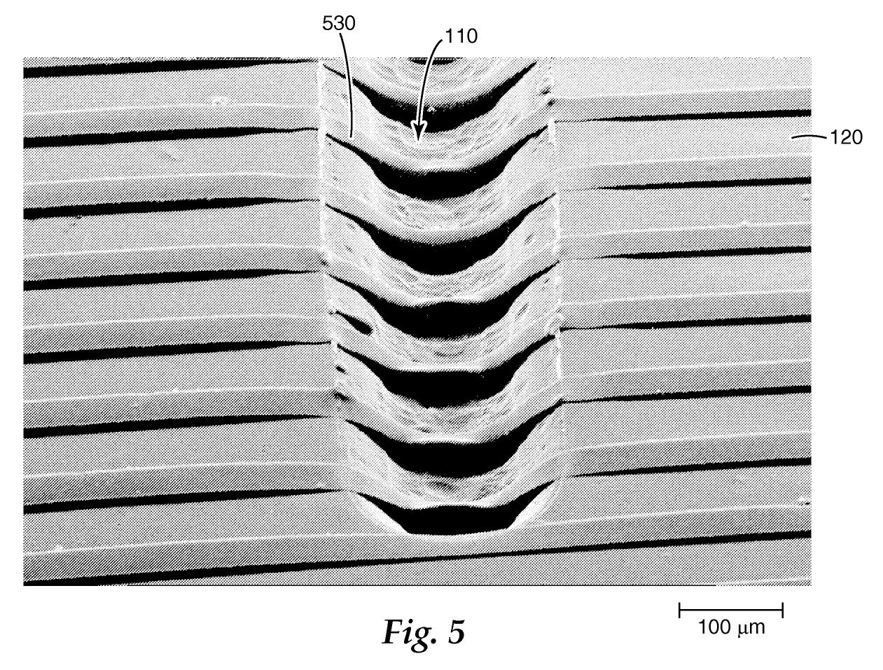

FIG. 4 illustrates a patterned dry film photoresist 440 bridging a channel 110 in the polymeric film 120. Whether the etchant is sprayed on the substrate or the substrate is submersed in an etchant solution, only the portion of copper in the channel that is not in the shadow of the photoresist is removed. This photoresist configuration works best when the conductive features in the channel have a pitch of about 100 micrometers or less. FIG. 5 illustrates a patterned liquid film photoresist 550 deposited in a channel 110 in the polymeric film 120. As can be seen from the figure, the photoresist is thin along the upper edges of the channel and tends to pool at the bottom of the channel. Nevertheless, the photoresist coverage is adequate to obtain well-defined conductive features.

A typical additive sequence, employing a chemical etching process, to form copper traces may be described as follows:

The polymeric substrate having a channel or feature on its surface is coated with a photoresist layer. Dry film aqueous processable photoresists are laminated, or liquid aqueous processable photoresists are coated, over both sides of the polymeric substrate, using standard laminating techniques. The thickness of the photoresist is from about 10 μm to about 50 μm. Under typical processing conditions, if the polymeric substrate feature has an aspect ratio of 3:1 or greater, a dry film resist may be used. If the polymeric substrate has an aspect ratio of less than about 3:1, a liquid resist may be preferable. The photoresist on the side of the substrate that will have metallic features is exposed to ultraviolet light or the like, through an imaging mask, causing the exposed portions of the photoresist to become insoluble by crosslinking. The resist is then developed, by removal of unexposed polymer with a dilute aqueous solution, e.g., a 0.5-1.5% sodium carbonate solution, until the desired pattern is obtained. Photoresist patterns such as those shown in FIGS. 4 and 5 may be used in the additive process.

The copper layer is then typically deposited by sputtering or vapor deposition. Optionally, a tie layer, such as chrome or nickel may be deposited before the copper layer. Typically, the substrate has a polymeric film layer of from about 25 μm to about 125 μm, with the copper layer being from about 1 to about 5 μm thick, and the optional tie layer being about 5 nm to about 30 nm thick.

The copper layer may then be further plated to form the desired copper features at the final desired thickness.

The photoresist is then stripped from both sides with a dilute basic solution in a 2-5% solution of an alkali metal hydroxide at from about 25° C. to about 80° C., preferably from about 25° C. to about 60° C.

When the photoresist pattern shown in FIG. 4 is used in an additive process, the area in the channel on which the copper is deposited is typically not well-defined, so the photoresist pattern shown in FIG. 5 is preferred for an additive process. The photoresist is then stripped from both sides with a dilute basic solution in a 2-5% solution of an alkali metal hydroxide at from about 25° C. to about 80° C., preferably from about 25° C. to about 60° C. Subsequently, exposed portions of the original thin copper layer (and the surface of the are etched using an etchant that does not harm the polymer film, e.g., PERMA ETCH, available from Electrochemicals, Inc. The etchant may be sprayed on the substrate or the substrate may be submerged in the etchant.

FIG. 6 shows an embodiment of the present invention comprising article 100 having a channel 110 formed in a polymeric film 120, with a series of 50 micrometer pitch parallel electrodes 140 located on the surface of polymeric film 20 and in channel 110.

FIG. 7 illustrated an embodiment of the present invention comprising article 700 having a polymeric substrate 710 with a first conductive feature 720 located on its front side. First conductive feature 720 includes first sloped conductive feature 730, which is a transition between section 720a of conductive feature 720 on one plane and section 720b of conductive feature 720 on another plane. First conductive feature 720 is made bi-planar by first sloped conductive feature 730 (or tri-planar if the direction of first sloped conductive feature 730 is considered.)

The subtractive and additive processes described above may be conducted as batch processes using individual steps or in automated fashion using equipment designed to transport a web material through the process sequence from a supply roll to a wind-up roll, which collects mass produced circuits. Automated processing uses a web handling device that has a variety of processing stations for applying, exposing and developing photoresist coatings, as well as etching the polymer film and etching, sputtering, and plating the metallic parts. Etching stations may include a number of spray bars with jet nozzles that spray etchant on the moving web to etch those parts of the web not protected by crosslinked photoresist, or may include etchant baths.

The surface properties of the flexible circuits can be changed by subjecting the surfaces, or portions thereof, to different types of treatments. For example, a diamond-like film such as diamond-like carbon (DLC) can be applied to fluid-transporting channels of microfluidic devices, for example as described in WO 01/67087 A2, to make them more hydrophilic or more hydrophobic. Making the surface more hydrophilic will allow an aqueous-based fluid to travel more easily and more readily through the channels. Making the surface more hydrophobic could provide a moisture barrier where desired. Corona, plasma, and flash lamp treatments can also be used to make the surface more hydrophobic or hydrophilic.

The diamond-like film, which can be applied using a plasma deposition method can be doped with various materials such as nitrogen, oxygen, fluorine, silicon sulfur, titanium, and copper, as taught in WO 01/67087 at p. 18, which allows the properties of the surface to be tailored for its particular use, e.g., by creating varying degrees of hydrophobicity.

Devices incorporating the flexible circuits of the present invention may comprise layers of materials adhered together, including flexible circuits adhered together.

Suitable adhesives include pressure sensitive adhesive, thermoset adhesive, or a thermoplastic adhesive, such as thermoplastic polyimide (TPPI) for use with a polyimide. In some applications, a wet chemically etchable adhesive may be preferred. The adhesive is typically applied in a very thin layer, e.g., in the range of about 0.5 to about 5 um thick. It may be applied using an adhesive transfer method. When a thermoplastic adhesive is used to adhere two layers together, typically the layers to be joined are heated to temperatures typically within 20° C. of each other, but about 30 to 60° C. above the Tg of the adhesive material, then the layers and the adhesive are pressed together, using heated opposing platens or rolls.

Devices incorporating the flexible circuits of the present invention may also comprise layers of materials joined together without adhesives, including flexible circuits joined together.

Thermoplastic films, such as liquid crystal polymers and polycarbonate, are suitable for forming a composite structure without the use of an adhesive. Thermoplastic films may be bonded to a polymeric substrate by using a solvent such as an etching solution containing an alkali metal salt and solubilizer to etchant treat a surface of the film. Other suitable solvents include methylene chloride, propylene glycol monomethyl ether (PGME), propylene glycol monomethyl ether acetate (PGMEA), and acetone.

Flash lamp polymer pretreatment and sealing technology can be used to self-seal multiple layers of LCP or other semicrystalline polymer films creating an adhesiveless seal as described in U.S. Pat. No. 5,032,209. The surface of at least one semicrystalline polymer film is irradiated with radiation, which is strongly absorbed by the polymer and of sufficient intensity and fluence to cause an amorphized layer. The semicrystalline polymer surface is thus altered into a new morphological state by radiation such as an intense short pulse UV excimer laser or short pulse duration, high intensity UV flashlamp. The resulting polymer layer with the amorphous surface may then be heat-sealed to another polymeric material by conventional means.

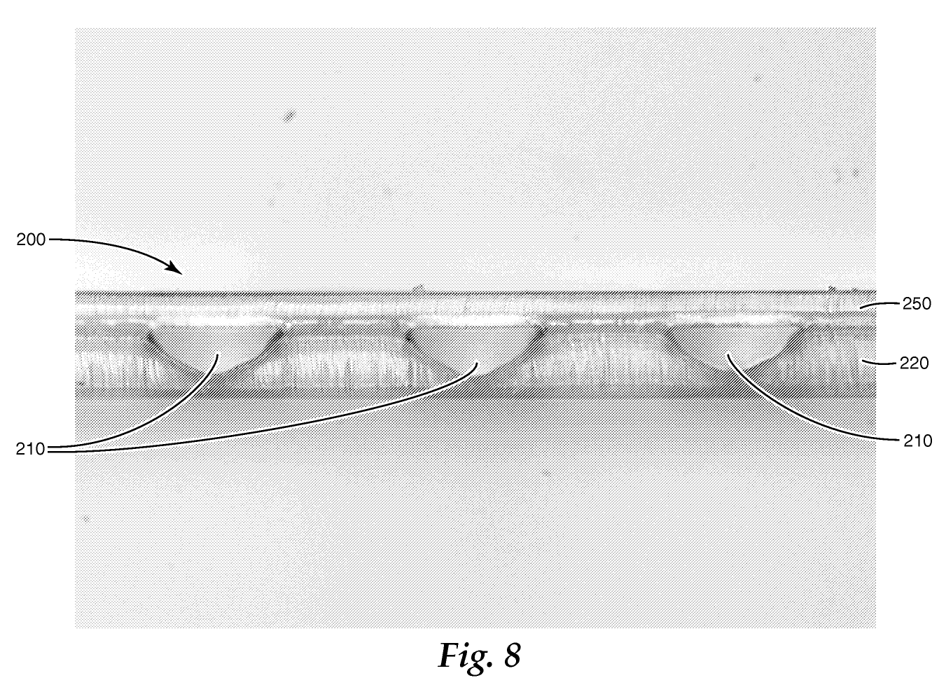

FIG. 8 illustrates an embodiment of the present invention comprising article 200 having three channels 210 formed in a polymeric film 220, with a flat film cover 250 to form closed channels. The film cover may be polymeric or non-polymeric and may be adhered adhesively or non-adhesively. The closed channels may be used, for example to control the flow of a fluid via capillary action.

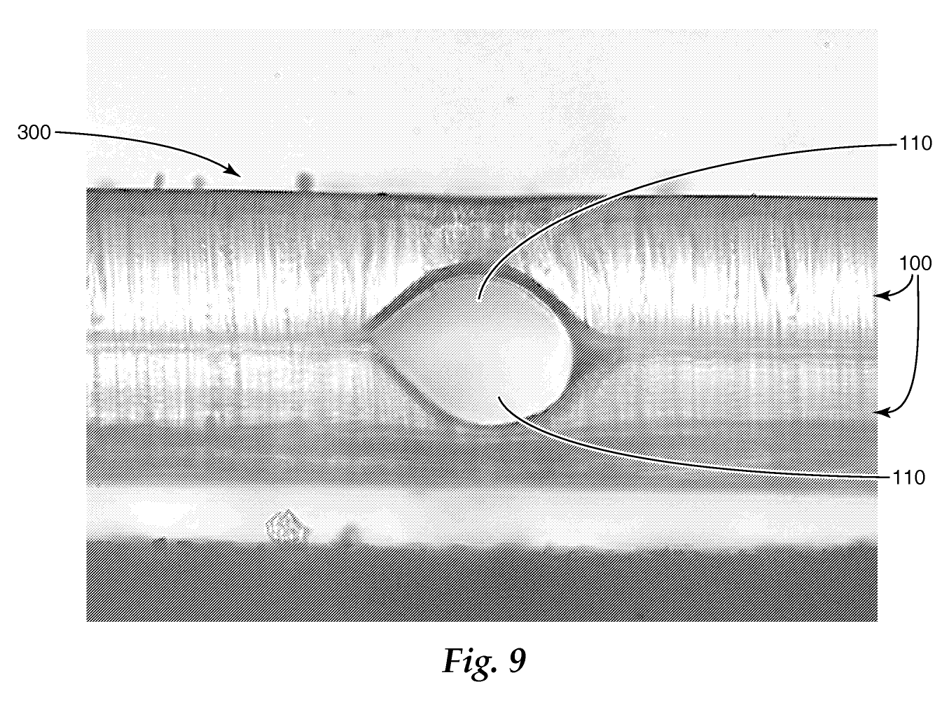

FIG. 9 illustrates an embodiment of the present invention comprising article 300 which is made by adhering together, adhesively or non-adhesively, the surfaces of two articles 100. In this embodiment, channels 110 are substantially aligned to form a tubular closed channel. The closed channels may be used, for example to control the flow of a fluid via capillary action. In other embodiments, the channels 110 of the two articles 100 may intersect or overlap each other at an angle between about 0° and 90° or may be offset from each other so that they are not in communication with each other.

Various modifications and alterations of this invention will become apparent to those skilled in the art without departing from the scope and spirit of this invention and it should be understood that this invention is not to be unduly limited to the illustrative embodiments set forth herein.

What is claimed is:

1. An article comprising:
a first polymeric substrate having in its surface at least one open channel comprising walls and a bottom surface and
at least one conductive feature on the polymeric substrate surface
wherein at least a portion of at least one conductive feature is located in at least one open channel.

2. The article of claim 1 wherein at least one open channel has a curvilinear cross-section.

3. The article of claim 1 wherein at least one open channel has a rectilinear cross-section.

4. The article of claim 3 wherein the walls and the bottom surface intersect at an angle between about 0° and about 90°.

5. The article of claim 4 wherein the angle is between about 25° and about 80°.

6. The article of claim 1 wherein at least one open channel includes an opening through the entire thickness of the polymeric substrate.

7. The article of claim 1 wherein the polymeric substrate comprises at last two layers of different polymeric material.

8. The article of claim 7 wherein the walls of the open channel comprise a different polymeric material than the bottom surface of the channel.

9. The article of claim 1 comprising a microfluidic device.

10. The article of claim 1 further comprising a second substrate in contact with the surface of the first polymeric substrate thereby forming a closed channel.

11. The article of claim 10 wherein the second substrate has a channel in its surface.

12. The article of claim 11 wherein the channel in the second substrate surface substantially aligns with a channel in the first substrate surface to form the closed channel.

13. A method comprising:
forming at least one channel in the surface of a first polymeric substrate and
forming at least one conductive feature on the polymeric substrate surface
such that at least a portion of at least one conductive feature is located in at least one channel.

14. The method of claim 13 wherein at least one conductive feature is formed by a process selected from the group consisting of additive, semi-additive, subtractive, and subtractive-additive.

15. The method of claim 14 wherein a photomask used in the conductive feature formation process is selected from the group consisting of a dry film photoresist, a liquid photoresist, and a metal mask.

16. The method of claim 14 wherein a liquid photoresist process is used.

17. The method of claim 15 wherein multiple conductive features are formed using a dry film photoresist pattern that bridges at least one channel.

18. The method of claim 17 wherein the conductive feature pattern pitch is about 100 micrometers or less.

19. The method of claim 17 wherein the exposed portions of the metal layer are etched away by submersing the polymeric substrate in an etchant bath.

20. An article comprising:
a polymeric substrate having on its surface at least one sloped conductive feature.

21. The article of claim 20 wherein the sloped conductive feature is between two substantially parallel planes of the polymeric substrate surface.

22. The article of claim 20 wherein the sloped conductive feature is located in a channel in the polymeric substrate surface.
